(19) United States
(12) Patent Application Publication
(10) Pub. No.: US 2015/0332601 A1
(43) Pub. Date: Nov. 19, 2015

(54) Piano Learning System

(71) Applicant: Walid Tamari, Beirut (LB)

(72) Inventor: Walid Tamari, Beirut (LB)

(21) Appl. No.: 14/702,517

(22) Filed: May 1, 2015

Related U.S. Application Data
(60) Provisional application No. 61/987,070, filed on May 1, 2014.

(51) Int. Cl. G09B 15/06

(52) U.S. Cl. CPC G09B 15/06

(57) ABSTRACT

A piano learning system includes a MIDI controller, a plurality of lights, a pair of color-coded gloves, and an external MIDI instrument, where the MIDI controller is electrically connected with the plurality of lights and the external MIDI instrument. The MIDI controller illuminates at least one light from the plurality of lights so that the user is able to practice the correct notes and the correct fingerings of a musical score through the external MIDI instrument. The illumination of the plurality of lights allows the user to match a correct finger sleeve of the pair of color-coded gloves and the correct hand so that the user can efficiently and correctly learn to play the piano.

The current application claims a priority to the U.S. Provisional Patent application Ser. No. 61/987,070 filed on May 1, 2014.

### FIELD OF THE INVENTION

The present invention relates generally to an electronic system which teaches the user musical pieces on the piano keyboard. The user is instructed to hit the correct keys with the correct fingers to play a musical piece of his/her choice. This is achieved by the use of colored lights mounted on the piano keyboard and colored gloves worn by the user. The user follows the colored lights on the keyboard and strikes them with the correct fingers (by matching the color of the finger on the colored glove to the color of the illuminated light). The present invention can be used both with an acoustic or an electric piano, the latter providing the advantage of feedback on the user's performance. The present invention is user-friendly system in reference to a computer software or application software which enables the selection of songs to be played, as well as controlling the speed and complexity of the musical piece.

### BACKGROUND OF THE INVENTION

A learning medium where the user can learn piano while interacting with an electronic system that can guide the user to play correctly, both the correct notes and correct fingering. In piano, some scores are annotated with the fingers to use for each note to play. When scores are not annotated, the player is supposed to know which fingers to use based upon experience. When some of the fingering becomes non-obvious, one often sees hints where a note is annotated with a finger number once in a while, in order to tell the player how to play the musical part in the most efficient way. Piano teachers can often add finger information to non-annotated scores to help the student. In the existing electronic systems however, fingering seems to be neglected and attempts to render these systems more accurate and user-friendly are limited. Some of the existing piano learning systems utilize computer software, which gives similar automated visual instructions to ours (notes and fingering), but these systems are displayed on the computer screen, which makes it very inconvenient since the user has to constantly look at both the computer screen with a shrunk version of the on-screen keyboard, and the real keyboard which can be difficult to match to the on-screen keyboard. Some piano learning systems include hardware like electric keyboards with integrated guiding lights (either above keyboard or inside the keys) so that the player is able to follow the sequence of the guiding lights as the learning method. However, these systems do not provide any information about the fingering. Some retrofitted piano learning systems include a strip of lights that can be mounted both on an electric and acoustic piano, but they also do not offer any fingering information, which make them very impractical for the players, especially when they are utilized by the beginners. It is also unclear which hand supposed to correspond with the notes, a feature which is very basic and important for any piano player.

The present invention is in the technical field of entertainment technology. More particularly, the present invention is in the technical field of interactive music learning. The present invention focus on the piano instrument; however the present invention is easily adaptable to other types of instruments including: keyboard instruments (organ, accordion, etc); wind instruments (saxophone, clarinet, piccolo, etc); string instruments (guitar, cello, bass, etc). The present invention visually brings the needed fingering instructions under the fingertips of the player while providing note instructions that greatly accelerate the piano learning process.

### BRIEF DESCRIPTION OF THE DRAWINGS

FIG. 1 is a basic illustration showing the components of the present invention.

FIG. 2 is a basic illustration showing the pair of color-coded gloves of the present invention.

FIG. 3 is a basic illustration showing the pair of color-coded gloves and the external MIDI instrument of the present invention.

FIG. 4 is a basic illustration of the overall method of the present invention.

FIG. 5 is a basic illustration showing the completion of the musical note within the overall method of the present invention.

FIG. 6 is a basic illustration showing the completion of the musical code within the overall method of the present invention.

FIG. 7 is a basic illustration showing the completion of the musical score with the overall method of the present invention.

### DETAIL DESCRIPTIONS OF THE INVENTION

All illustrations of the drawings are for the purpose of describing selected versions of the present invention and are not intended to limit the scope of the present invention.

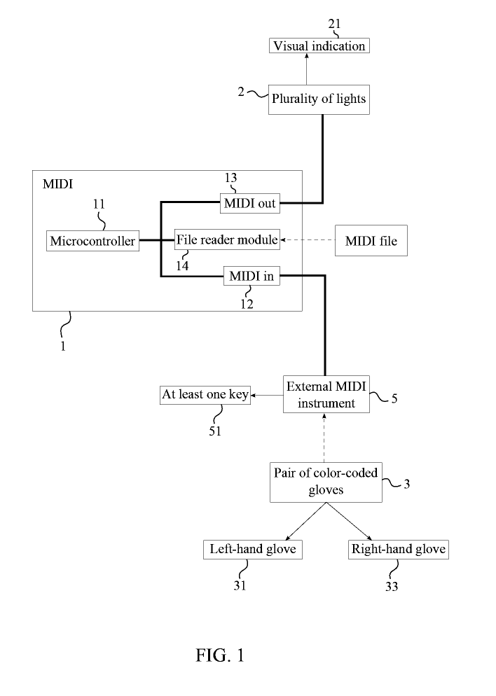

The present invention is a piano learning system that enables a user to correctly practice and play a musical score as the user is able to learn both the correct notes and the correct fingering. The present invention comprises a musical instrument digital interface (MIDI) controller 1, a plurality of lights 2, a pair of color-coded gloves 3, and an external MIDI instrument 5. In reference to the general configuration of the present invention that is shown in FIG. 1, the MIDI controller 1 is electrically connected with the plurality of lights 2 and the external MIDI instrument 5. The user is able selectively engage the pair of color-coded gloves 3 with the external MIDI instrument 5 as the pair of color-coded gloves 3 is worn by the user during the process.

The MIDI controller 1 can be an individual hardware unit or a software based computer unit, where the MIDI controller 1 transmits MIDI data to MIDI enabled devices such as the plurality of lights 2. In reference to FIG. 1, the MIDI controller 1 comprises a microcontroller 11, a MIDI in 12, a MIDI out 13, and a file reader module 14. The MIDI in 12 and the file reader module 14 provide hardware connections so that the MIDI controller 1 is able receive MIDI data from other components of the present invention. The MIDI out 13 provides a hardware connection within the MIDI controller 1 and transmits MIDI data to MIDI enabled devices. The MIDI in 12, the MIDI out 13, and the file reader module 14 are electronically connected with the microcontroller 11 that functions as the central processing unit of the MIDI controller 1. More specifically, the MIDI in 12 is electrically connected with the external MIDI instrument 5 so that the MIDI controller 1 is able to receive a feedback loop from the external MIDI instrument 5. The feedback loop can be only received from an electric piano and provides information regarding the musical score. For example, the feedback loop is able to inform the MIDI controller 1 that the correct note has been played before moving to the next note. More specifically, the feedback loop sends back information to the MIDI controller 1 through MIDI in 12 and commands corresponding to the piano keys that the user strikes. Then the microcontroller 11 is able to compare the note that has been played with reference to the MIDI data in order to trigger the resulting actions, such as moving to the next note or signaling an error. An acoustic piano is not able to provide the feedback loop to the MIDI controller 1 as the acoustic piano does not electrically connect with the MIDI in 12.

In reference to FIG. 1, the MIDI out 13 is electrically connected with the plurality of lights 2 so that the MIDI controller 1 is able to transmit MIDI data to the plurality of lights 2. More specifically, the microcontroller 11 of the MIDI controller 1 receives MIDI data from the feedback loop through the MIDI in 12 and/or a MIDI file that is inserted into the file reader module 14. Then the MIDI data is processed through the microcontroller 11 and transmitted into the plurality of lights 2, where the microcontroller 11 has enough clock speed to respond in real-time to incoming MIDI data. The MIDI controller 1 also allows the user to control the tempo of the MIDI data and to repeat the MIDI data for multiple practice.

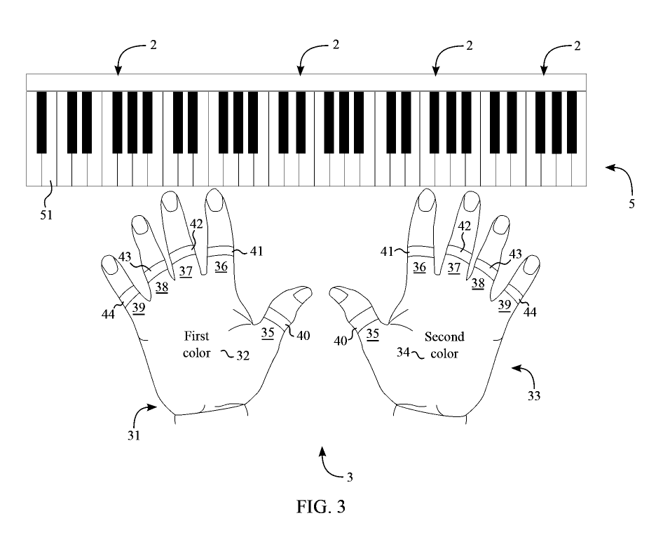

The plurality of lights 2 of the present invention is preferably light emitting diodes (LEDs) that are in series connection and uses only one data pin to transmit light information in a serial fashion. The plurality of lights 2 functions according the microcontroller 11 in such a way that each of the plurality of lights 2 is sequentially illuminated with a visual indication 21. More specifically, the visual indication 21 provides correct note and correct fingering instructions to the user so that the user is able to play a musical score. The visual indication 21 of the plurality of lights 2 comprises a first reference color, a second reference color, a third reference color, a fourth reference color, a fifth reference color, a sixth reference color, and a seventh reference color. Each different reference colors of the visual indication 21 provides an effective method so that the user is able to play and learn a musical score through the usage of the pair of color-coded gloves 3. In reference to FIG. 3, the plurality of lights 2 can be mounted over the piano keys and match the spacing of both the white and black piano keys. In order to mount the plurality of lights 2 over the piano keys, the plurality of lights 2 is soldered on a piece of flexible printed circuit board as a light strip, to enable rolling the light strip and occupying minimal space when unused. Additionally, each of the plurality of corresponding lights 2 to black and white keys is slightly misaligned so that the user can easily identify and strike the correct piano key. The light strip can be placed horizontally and directly on the end of the piano keys. In reference to FIG. 3, the light strip is shown with a partial keyboard; the actual light strip contains replicas of what is shown in FIG. 3 to cover the full keyboard of the whole piano. Alternatively, the plurality of lights 2 can be embedded into the piano keys instead of being mounted over the piano keys.

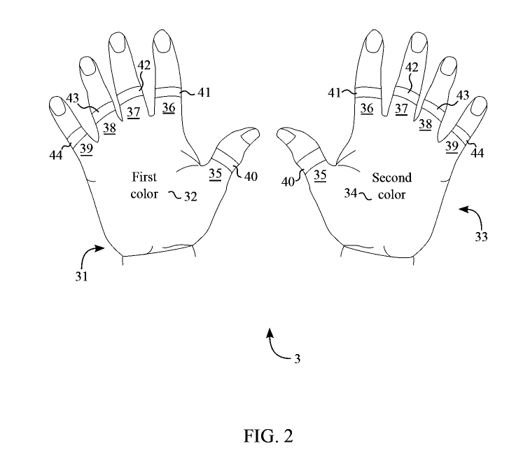

The pair of color-coded gloves 3 has to be non-cumbersome, so it is advisable to keep the tips of the fingers uncovered and to use an elastic fabric that would allow good flexibility in the hand movement. In reference to FIGS. 2 and 3, the pair of color-coded gloves 3 comprises a left-hand glove 31 and a right-hand glove 33. The left-hand glove 31 is identified through a first color 32 as the first color 32 is assigned to the left-hand glove 31. Similarly, the right-hand glove 33 is identified through a second color 34 as the second color 34 is assigned to the right-hand glove 33. The first color 32 and the second color 34 are displayed through a color path that is located on the top surface of the left-hand glove 31 and the right-hand glove 33 respectively. Additionally, each glove of the pair of color-coded gloves 3 further comprises a thumb sleeve 35, an index sleeve 36, a middle sleeve 37, a ring sleeve 38, and a pinky sleeve 39 as each sleeve of the pair of color-coded gloves 3 is individually recognized through different color scheme. More specifically, the thumb sleeve 35 is colored with a first indicator color 40, the index sleeve 36 is colored with a second indicator color 41, the middle sleeve 37 is colored with a third indicator color 42, the ring sleeve 38 is colored with a fourth indicator color 43, and the pinky sleeve 39 is colored with a fifth indicator color 44.

For the efficient usage of the present invention, the first reference color, the second reference color, the third reference color, the fourth reference color, the fifth reference color are respectively matched with the first indicator color 40, the second indicator color 41, the third indicator color 42, the fourth indicator color 43, and the fifth indicator color 44. Additionally, the sixth reference color is matched with the first color 32 while the seventh reference color is matched with the second color 34.

When the present invention is utilized by the user, the pair of color-coded gloves 3 is pressed against at least one key 51 of the external MIDI instrument 5 as the at least one key 51 corresponds to one of the visual indication 21 of the plurality of lights 2. The user is able individually practice with either the left-hand glove 31 or the right-hand glove 33 or both the left-hand glove 31 and the right-hand glove 33 when the user presses the at least one key 51 corresponds with the plurality of lights 2 to complete the musical score.

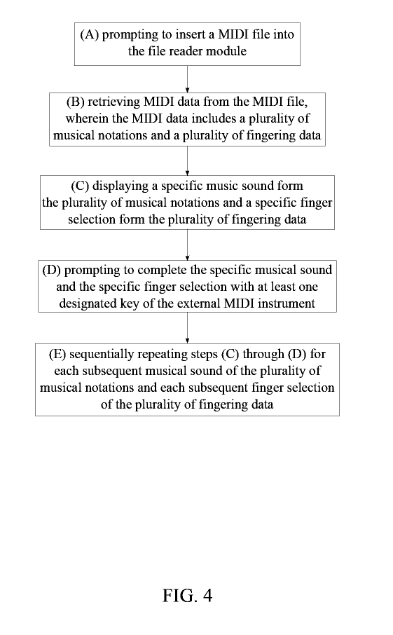

Referring to FIG. 4 that illustrates the usage of the present invention, the user plays a musical score using the MIDI controller 1 as the MIDI controller 1 instructs how to perform the musical score on the external MIDI instrument 5. The MIDI controller 1 is able to perform these commands through the MIDI data that includes a plurality of musical notations and a plurality of fingering data. In reference to the general data flow, the MIDI controller 1 commands the microcontroller 11 through the MIDI in 12. These commands contain the plurality of musical notations as traditionally note-on and note-off commands in the general MIDI protocol. However, since no bits are assigned in this protocol for the plurality of fingering data, the MIDI controller 1 uses unneeded bits like the four channel bits or even the velocity byte to encode the plurality of fingering data along with the note-on and note-off commands.

In order to perform the musical score, the MIDI controller 1 displays a specific music sound from the plurality of musical notations and a specific finger selection from the plurality of fingering data to the user so that the user is able to complete the specific musical sound and the specific finger selection with at least one designated key of the external MIDI instrument 5. Additionally, the user is able practice with the right-hand glove 33 and the left-hand glove 31 alone at his/her own pace since the present invention detects the striking of the at least one key 51 through the feedback loop. Since right-hand glove 33 and the left-hand glove 31 allow the user to individually practice the musical score, no more than five colors are need at a time as the reference colors of the visual indication 21.

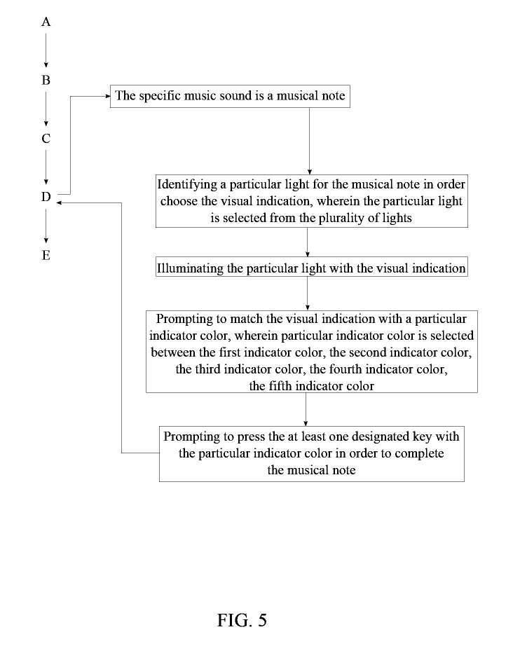

In reference to FIGS. 4 and 5, when the specific music sound is a musical note, the MIDI controller 1 identifies a particular light from the plurality of lights 2 for the musical note. The MIDI controller 1 then chooses the visual indication 21 while the particular light is selected from the plurality of lights 2. Then the particular light is illuminated with the visual indication 21, prompting the user to match the visual indication 21 with a particular indicator color as the particular indicator color is selected between the first indicator color 40, the second indicator color 41, the third indicator color 42, the fourth indicator color 43, the fifth indicator color 44. The MIDI controller 1 then prompts the user to press the at least one designated key with the particular indicator color in order to complete the musical note. In other words, the user matches the visual indication 21 with one of the sleeve of the right-hand glove 33 or the left-hand glove 31 so that the musical note can be completed with the correct note and the correct fingering. Since the MIDI controller 1 specifies the usage of the left-hand glove 31 or the right-hand glove 33 before the visual indicator is illuminated, the user does not have figure out which hand to use in order to complete the musical note.

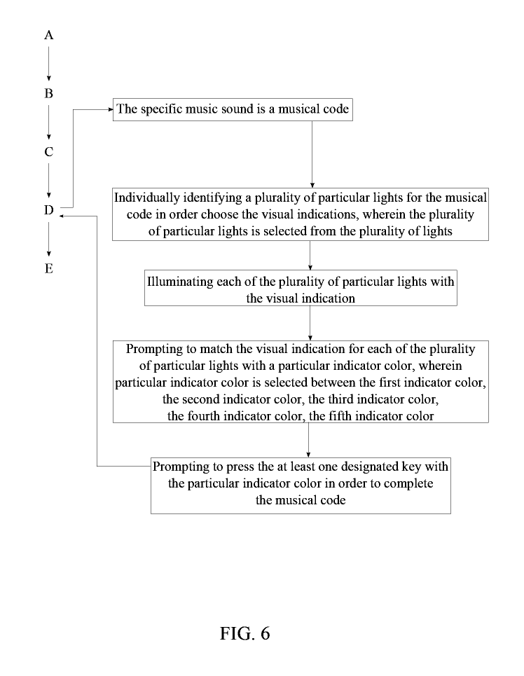

In reference to FIGS. 4 and 6, when the specific music sound is a musical code, the MIDI controller 1 identifies a plurality of particular lights from the plurality of lights 2 for the musical code. The MIDI controller 1 then chooses the visual indications 21 while the plurality of particular lights is selected from the plurality of lights 2. Then each of plurality of the particular lights is illuminated with the visual indication 21, prompting the user to match the visual indication 21 with the particular indicator color. The MIDI controller 1 then prompts the user to press the at least one designated key with the particular indicator color in order to complete the musical code. In other words, the user matches the visual indications 21 with at least two sleeves of the right-hand glove 33 or the left-hand glove 31 so that the musical code can be completed with the correct notes and the correct fingerings. Since the MIDI controller 1 specifies the usage of the left-hand glove 31 or the right-hand glove 33 before the visual indicators are illuminated, the user does not have figure out which hand to use in order to complete the musical code.

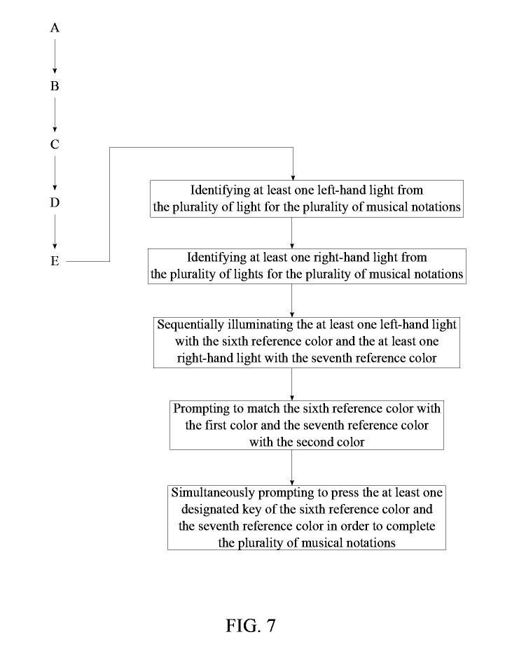

In reference to FIGS. 4 and 7, once the specific musical sound is completed with the specific fingering selection, the user can sequentially repeat the completion of the specific musical sound and the specific fingering selection for each subsequent musical sound of the plurality of musical notations and each subsequent finger selection of the plurality of fingering data. This allows the user to practice the plurality of musical notations with the plurality of fingering data with each hand until the musical score is memorized so that the user can incorporate both hands to play the musical score. When the user is ready to use both hands, the MIDI controller 1 needs to be switched into a continuation-play-mode so that the MIDI controller 1 is able to continuously transmit MIDI data to the plurality of lights 2. Then only the sixth reference color and the seventh reference color are shown with the plurality of lights 2 enabling the user to play like a traditional piano user, without the help of the specific musical sounds and the specific fingering selections. The sixth reference color and the seventh reference color instruct the user what hand to use during the completion of the plurality of musical notations. More specifically, the MIDI controller 1 identifies at least one left-hand light and at least one right-hand light from the plurality of lights 2 in order to indicate the plurality of musical notations during the continuation-play-mode. The MIDI controller 1 then sequentially illuminates the at least one left-hand light with the sixth reference color and the at least one right-hand light with the seventh reference color. The illumination of the at least one left-hand light and the at least one right-hand light prompt the user to match the sixth reference color with the first color 32 and the seventh reference color with the second color 34. At the same time, the user is prompted to press the at least one designated key of the sixth reference color and the seventh reference color in order to continuously complete the plurality of musical notations.

Alternatively, the visual indication 21 of the plurality of lights 2 can be replaced by tiny seven-segment displays that show numbers corresponding to the pair of color-coded gloves 3. In other words, each finger sleeve of the pair of color-coded gloves 3 is numbered instead of indicator colors, to match the seven-segment illumination of the plurality of lights 2.

The advantages of the present invention include, without limitation, a high amount of accuracy in the instructions to play a certain musical score as it incorporates correct notes with correct fingers, which is very important when one learns to play the piano. Through the proper use of the present invention, the user can practice and memorize musical score faster, and get feedback in real-time as if he/she has a personal instructor accompanying him/her at all times.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The present invention should therefore not be limited by the above described embodiment, method, and examples, but by all embodiments and methods within the scope and spirit of the invention.

Although the invention has been explained in relation to its preferred embodiment, it is to be understood that many other possible modifications and variations can be made without departing from the spirit and scope of the invention as hereinafter claimed.

What is claimed is:

1. A piano learning system comprises:
a musical instrument digital interface (MIDI) controller;
a plurality of lights;
a pair of color-coded gloves;
an external MIDI instrument;
the MIDI controller comprises a microcontroller, a MIDI in, a MIDI out, and a file reader module;
the pair of color-coded gloves comprises a left-hand glove and a right-hand glove; and
the MIDI controller being electrically connected with the plurality of lights and the external MIDI instrument.

2. The piano learning system as claimed in claim 1 comprises:
the MIDI in, the MIDI out, and the file reader module being electronically connected with the microcontroller.

3. The piano learning system as claimed in claim 1 comprises:
the MIDI in being electrically connected with the external MIDI instrument, wherein the MIDI in receives a feedback loop from the external MIDI instrument.

4. The piano learning system as claimed in claim 1 comprises:
the MIDI out being electrically connected with the plurality of lights.

5. The piano learning system as claimed in claim 1 comprises:
each of the plurality of lights being sequentially illuminated with a visual indication, wherein the visual indication is a first reference color, a second reference color, a third reference color, a fourth reference color, a fifth reference color, a sixth reference color, or a seventh reference color.

6. The piano learning system as claimed in claim 1 comprises:
each glove of the pair of color-coded gloves comprises a thumb sleeve, an index sleeve, a middle sleeve, a ring sleeve, and a pinky sleeve;
the thumb sleeve being colored with a first indicator color;
the index sleeve being colored with a second indicator color;
the middle sleeve being colored with a third indicator color;
the ring sleeve being colored with a fourth indicator color; and
the pinky sleeve being colored with a fifth indicator color.

7. The piano learning system as claimed in claim 1 comprises:
the left-hand glove being assigned to a first color; and
the right-hand glove being assigned to a second color.

8. The piano learning system as claimed in claim 1 comprises:
the left-hand glove being selectively pressed against at least one key of the external MIDI instrument, wherein the at least one key corresponds to a visual indication of the each of the plurality of lights.

9. The piano learning system as claimed in claim 1 comprises:
the right-hand glove being selectively pressed against at least one key of the external MIDI instrument, wherein the at least one key corresponds to a visual indication of the each of the plurality of lights.

10. A method of teaching a piano lesson as claimed in claim 1 comprises the steps of:
(A) prompting to insert a MIDI file into the file reader module;
(B) retrieving MIDI data from the MIDI file, wherein the MIDI data includes a plurality of musical notations and a plurality of fingering data;
(C) displaying a specific music sound form the plurality of musical notations and a specific finger selection form the plurality of fingering data;
(D) prompting to complete the specific musical sound and the specific finger selection with at least one designated key of the external MIDI instrument; and
(E) sequentially repeating steps (C) through (D) for each subsequent musical sound of the plurality of musical notations and each subsequent finger selection of the plurality of fingering data.

11. The method of teaching a piano lesson as claimed in claim 1, wherein the specific music sound is a musical note.

12. The method of teaching a piano lesson as claimed in claim 12 comprises the steps of:
identifying a particular light for the musical note in order choose the visual indication, wherein the particular light is selected from the plurality of lights;
illuminating the particular light with the visual indication;
prompting to match the visual indication with a particular indicator color, wherein particular indicator color is selected between the first indicator color, the second indicator color, the third indicator color, the fourth indicator color, the fifth indicator color; and
prompting to press the at least one designated key with the particular indicator color in order to complete the musical note.

13. The method of teaching a piano lesson as claimed in claim 1, wherein the specific music sound is a musical code.

14. The method of teaching a piano lesson as claimed in claim 14 comprises the steps of:
individually identifying a plurality of particular lights for the musical code in order choose the visual indications, wherein the plurality of particular lights is selected from the plurality of lights;
illuminating each of the plurality of particular lights with the visual indication;
prompting to match the visual indication for each of the plurality of particular lights with a particular indicator color, wherein particular indicator color is selected between the first indicator color, the second indicator color, the third indicator color, the fourth indicator color, the fifth indicator color; and
prompting to press the at least one designated key with the particular indicator color in order to complete the musical code.

15. The method of teaching a piano lesson as claimed in claim 12 comprises the steps of:
identifying at least one left-hand light from the plurality of light for the plurality of musical notations;
identifying at least one right-hand light from the plurality of lights for the plurality of musical notations;
sequentially illuminating the at least one left-hand light with the sixth reference color and the at least one right-hand light with the seventh reference color;
prompting to match the sixth reference color with the first color and the seventh reference color with the second color; and
simultaneously prompting to press the at least one designated key of the sixth reference color and the seventh reference color in order to complete the plurality of musical notations.
